(19) United States
(12) Patent Application Publication
(10) Pub. No.: US 2008/0040136 A1
(43) Pub. Date: Feb. 14, 2008

(54) Distributed Authorisation System

(75) Inventor: Michael Eliot Voss, Marton (NZ)

Correspondence Address: YOUNG & THOMPSON, 745 SOUTH 23RD STREET, 2ND FLOOR, ARLINGTON, VA, 22202, US

(73) Assignee: LEYHATTON INNOVATIONS LIMITED, WELLINGTON (NZ)

(21) Appl. No.: 11/631,853

(22) PCT Filed: Jul. 7, 2005
(86) PCT No.: PCT/NZ05/00164

§ 371 Date: Jan. 8, 2007

(30) Foreign Application Priority Data
Jul. 7, 2004 (NZ) 533951

(51) Int. Cl. G06Q 30/00

(52) U.S. Cl. 705/1

(57) ABSTRACT

A distributed authorisation system whereby seals 15 can be uniquely numbered and applied to a package or product P. The system includes an authorisation site 11 from which a licensed applicator 10 of security seals, marking, labels and the like can obtain via a global networking system 13 a unique number or series of unique numbers. A licensing authority 12 is able, via the networking system 13, to audit the activities of the authorisation site 11 and the licensed applicator 10.

### BACKGROUND TO THE INVENTION

This invention relates to a distributed authorisation system.

Internationally there is increasing concern arising out of goods being tampered with during packaging, transportation or generally during passage of goods from the source of manufacture to the distributor or end user. Products such as foodstuffs, beverages and other consumables are susceptible to tampering and these include pharmaceutical products. Thus, it is common that packaging of goods, or in some cases the actual goods or products, are marked with a security label. This not only indicates that the package/product is bona fide but provides evidence (by the label not being intact) of tampering.

Also there is increasing evidence of such security labels being misused or products being marked with false security labels. This is particularly of concern with consumable products, pharmaceuticals and the like where substandard products are passed off as having the same standards as those associated with a producer of quality products authorised to apply a recognised security label.

By way of one example it is already common practice in the meat processing industry that product destined for export be packaged in a carton (or other package), which is sealed and to which is applied a security/certification label e.g. a Ministry of Agriculture and Fisheries (“MAF”) seal.

MAF seals (each carrying its own unique number or code) are produced by MAF and then supplied to meat processing works where they are held in secure storage.

Typically at the start of a shift (i.e. processing period) a vet (MAF inspector) will remove from the secure storage a quantity of MAF security labels (seals) estimated as being sufficient to enable seals to be applied to all packages produced during that shift. The MAF inspector will note the block of numbers of the seals and this will be recorded.

Unfortunately it has been found that seals become lost, unaccounted for (e.g. pilfered) or possibly inadvertently damaged/destroyed therefore, there is no guarantee that the number of seals distributed at the start of a shift are actually applied to packages. Also there is the possibility that seals leftover at the end of a shift are not returned to the secure storage. Therefore there is always the possibility that seals can be misappropriated and used later for fraudulent purposes.

In any event the MAF seal does not always provide a tamper evident means of sealing packages. For example the seals are not incapable of being altered. Furthermore, the seal could possibly be removed and then reused in a fraudulent manner. Consequently, known seals do not generally fulfil the dual function of permanent (indelible) marking and being tamper-proof or at least tamper-evident.

Similar systems may apply in other industries or may become necessary as time goes by in order to achieve secure marking of product, packages of product etc.

### SUMMARY OF THE INVENTION

There is therefore a need for a system which provides a more controlled secure and accurate authorisation of the use of security marking seals, security labels and the like for packaging or even individual products whereby it becomes possible to ensure that a security marking is only used for its intended purpose and preferably also provides traceability of individual security markings.

An object of the present invention is thus to provide such a system.

According to one broad aspect of the invention there is provided a distributed authorisation system, the system including an authorisation site from which a licensed applicator of security seals, markings, labels and the like (herein “security seals”) can obtain via a global networking system a unique number or series of unique numbers and a licensing authority able to audit via the global networking system the activities of the authorisation site and licensed applicator.

### BRIEF DESCRIPTION OF THE DRAWINGS

In the following description of the invention in more detail and in accordance with a preferred form of the invention reference will be made to the accompanying drawings in which:—

FIG. 1 is a schematic illustration of the distributed authorisation system according to the invention, and

FIG. 2 is a schematic illustration of the part of the system at the licensed applicator.

### DETAILED DESCRIPTION OF A PREFERRED EMBODIMENT OF THE INVENTION

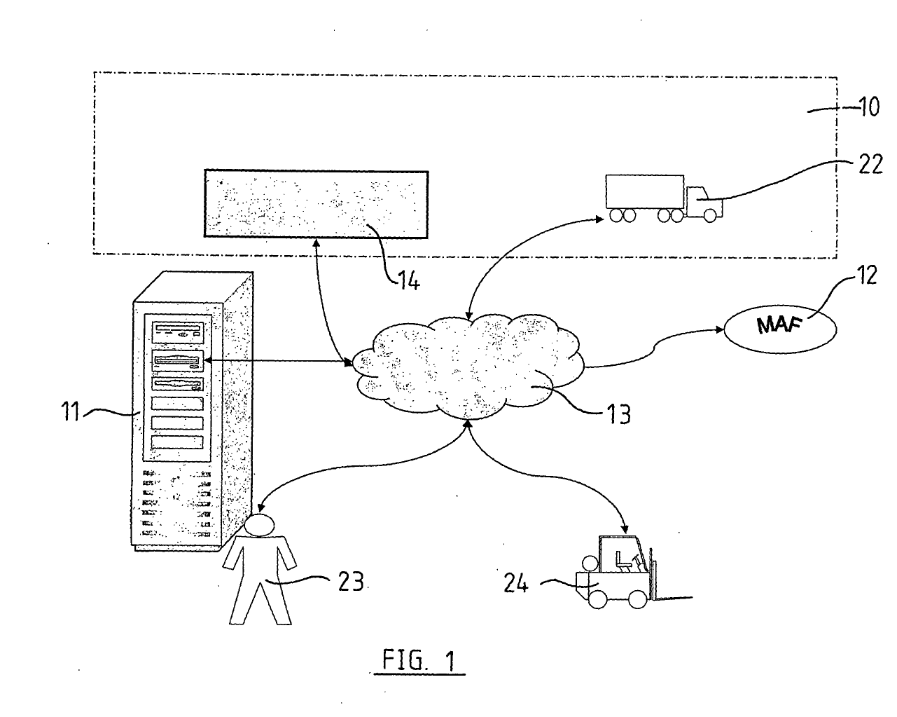

Referring firstly to FIG. 1, the system includes the key elements of a so-called licensed applicator at a local site 10, a centralised authorisation site 11 and a licensing authority 12 all communicating through a server 13 of a global networking system, e.g. the Internet. For the sake of simplicity the system is shown in FIG. 1 as only incorporating one local site 10 but in reality there will be a plurality of sites 10 distributed over one or more geographical areas.

For the purposes of description the following will specifically describe the system in the context of the meat processing industry. This is by way of example and it will be appreciated by those skilled in the art that the system has a vast range of applications now and in the future. Thus the invention is not limited to solely application in the meat processing industry.

Therefore, when considering the meat processing industry, in particular, each local site 10 will be a meat processing plant distributed throughout a country or possibly a number of countries. Accordingly, at each local site 10 the meat company will be licensed to apply a security seal. In one form of the invention the seal will actually be created at the local site or else the number applied to (incorporated in) the seal at the time of application to the package or product.

Thus according to one preferred form of the invention there will be one or a number of printing devices 14 at the local site which may, or may not, be directly associated with a packaging machine or product processing equipment. Thus, by way of example the printing device 14 may be incorporated directly with the packaging machine. Thus each packaging machine would have its own printing device 14.

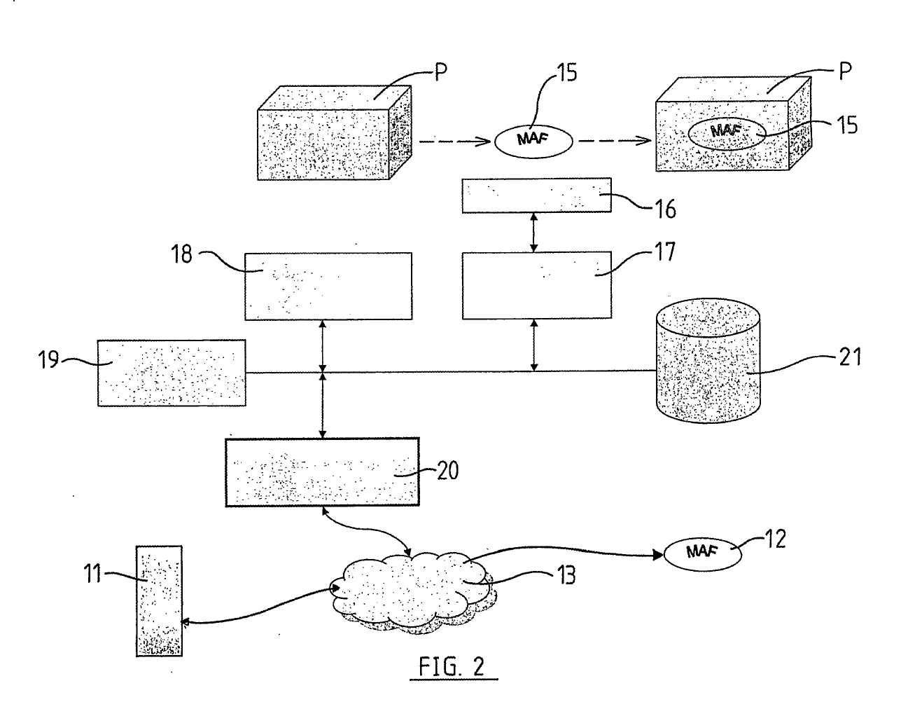

Once again, by way of example and referring to the meat processing industry, the licensing authority 12 will be an authority such as MAF. The licensing authority 12 will licence the meat processor at the local site 10 to create (e.g. print) MAF seals (labels) 15 (see FIG. 2).

As part of the license between the meat processor and MAF it will be a requirement that via the global network and server 13 the licensing authority 12 will be able to audit the activities of the meat processor. Thus, for example, the licensing authority 12 will be able to validate and verify that the activities of the meat processor in regard to creation/application of security seals are in accordance with the terms of the license.

It is, therefore, believed that according to the present system this ability of the licensing authority 12 to validate and verify the activities of the meat processor at the local site 10 will result in, for example, lower compliance costs to the meat processor.

The centralised authorisation site 11 will be administered by an organisation independent of the licensing authority 12. The authorisation site 11 will be able to allocate blocks of numbers, these being the unique numbers to be applied to the MAF security seals.

It will be appreciated that while a centralised authorisation is referred to herein there could be a number of authorisation sites 11.

Thus, in the meat processing plant 10 at the start of a shift, or commencement of a predetermined time period, the vet (MAF inspector) at the plant will be able to log onto the server 13 and obtain from the authorisation site 11 a block of numbers to be used for the printing of seals during that shift or period of time. Prior to issuing the block of numbers the authorisation site 11 will check the regulations and other information applicable to that local site 10 and then issue the block of numbers either in their entirety or by a lesser amount.

For example, if the block of numbers requested by the local site 10 is greater than the quantity of numbers normally required for previous through put of product by the plant in a shift (or time period) the authorisation site 11 may issue a lesser quantity of numbers than that requested by the local site 10. Also, a lesser number might be allocated in the event that an earlier or current audit, by the authorisation site 11, has determined that the local site has “in stock” numbers which have not been used.

Referring to FIG. 2, there is shown a typical system at a local site 10 of a licensed applicator.

At the local site 10 a seal in the form of a label 15 is printed by a printing device 16 and the label 15 is applied (preferably automatically at completion of printing) to a package P. Thus at completion of loading of the package the printing device 16 will be activated by a printer control 17 to print label 15 following which the label is applied to the P package (e.g. a carton). The MAF label 15 will be printed with one of the block of numbers allocated by the authorisation site 11.

In a preferred form of the invention the printing device 14 will print the label 15 in a manner such that the printing is indelible and the label is tamper-evident such that any tampering of the label is visibly evident.

### DESCRIPTION OF THE PREFERRED EMBODIMENT OF THE INVENTION

Accordingly, FIG. 2 shows a preferred arrangement whereby a closure controller 18, which applies sealing/closure tape, bands or the like to the package P is linked to the print control 17, both of which are in turn operated through a user interface 19.

The local site 10 is coupled to the server 13 via a firewall 20. The local system is completed by database 21.

As a result the numbers authorised for use from the centralised authorisation site 11 are stored in the database 21. Each time the print control 17 operates the printing device 16, the label 15 so printed is printed with an authorised numbers drawn from the database.

The user interface 19 thus permits the database 21 to be updated with appropriate information pertaining to the package P to which the security seal 15 bearing the number has been applied.

The meat processor database 21 thus stores and administers the use of the MAF seal serial number block allocation. It also receives and stores information relative to each package P.

At the end of each shift (or time period) the local site database 21 can report to or be interrogated by the authorisation site 11 and/or licensing authority 12. The local site database 21 thus can provide details of site location and the serial number of the or each printing device 14 (or packaging machine if the printing device is formed as part of the machine). The database 21 also provides details of the numbers of each carton type closed and the MAF serial numbers used in relation to the cartons.

Accordingly, if all of the allocated numbers are not used during the shift the number of unused numbers will be stored on database 21 and can be taken into account when the authorisation site 11 next allocates a requested block of numbers. The number of cartons P closed and hence the number of seals 15 applied during the shift (or time period) can also be used as a means of verifying whether a requested block of numbers is historically an appropriate quantity for a shift (or time period).

It will be appreciated by those skilled in the art that the system is one which facilitates storage and supply of information. The system can thus provide the basis for a full e-commence capability. Consequently the meat processor database 21 can provide information on every carton type closed, contents of each carton and the like as well as shipping details in respect of every carton. This information can be selectively accessible via the global network 13 by key stake holders and can be used, for example, for invoicing, direct debiting, traceability of product, auditing of throughput, and other relevant commercially valuable information.

Consequently, not only does the present invention provide for a distributed authorisation system but it can also provide the basis for means to reduce administrative costs not only within the local site, i.e. the meat processing plant, but also in the administration and verification of use of security seals. The misuse of seals is also eliminated as a seal is only produced for a specific package at the time of sealing of the package.

While the present invention has been described in relation to a meat processing plant it will be appreciated by those skilled in the art that the system is applicable to all manner of packaging or, indeed, product marking requirements over a wide range of goods, not only consumables.

The system according to the invention is open to modification. For example, transportation of packages can be logged, tracked and audited by linking trucks 22 through server 13. Furthermore, a material supplier 23 can be linked into the system such that the database 21 at the local site 10 can provide to supplier 23 a theoretical stock level and delivery schedule for product/consumables required for creating seals. Also the supplier 23 can make appropriate data entry of inventory stock at the local site 10 and quantity of product/consumables delivered.

Similarly, a maintenance engineer 24 can be provided, from database 21, with a maintenance history of the or each machine/printer and machine event log. The maintenance engineer 24 is thus facilitated in making its own data entry from the local site of maintenance work carried out and parts used and replaced.

Thus, invoicing and direct debit transactions may be effected by the system for transportation, material supply management and maintenance activities.

1-19. (canceled)

20. A distributed authorisation system, the system including an authorisation site from which a licensed applicator of security seals, markings and labels (herein “security seals”) can obtain via a global networking system a unique number or series of unique numbers and a licensing authority able to audit via the global networking system the activities of the authorisation site and licensed applicator.

21. The system of claim 20 further including a database to store the unique number(s) prior to applications thereof to security seals.

22. The system of claim 21 wherein the database is connected via an interface to a printer control.

23. The system of claim 22 wherein one or more printing devices are coupled to the printer control, the printer control being arranged to cause the printing device operated by the printer control to print a seal with a unique number taken from the database.

24. The system of claim 23 wherein the or each printing device forms part of packaging equipment.

25. The system of claim 22 wherein information pertaining to a package or product to which a seal has been applied can be supplied to the database to update the database.

26. The system of claim 25 wherein the update information is supplied via the interface.

27. The system of claim 21 wherein the database is able to report to and/or be interrogated by the licensing authority and authorisation site.

28. The system of claim 27 wherein the database is located at a local site of the licensed applicator.

29. The system of claim 22 further including a package closure controller linked to the printer control.

30. The system of claim 20 wherein the authorisation site can allocate all or some of the numbers requested by the licensed applicator following auditing by the authorisation site of the numbers previously obtained by the licensed operator but not applied by the licensed operator to seals.

31. The system of claim 20 wherein the authorisation site can allocate numbers to the licensed applicator based on historical data.

32. The system of claim 20 wherein the system is accessible, in whole or in part, via the global network by authorised users as part of an e-commerce system.

33. The system of claim 20 further including means for logging, tracking and auditing transportation means via the global network.

34. The system of claim 20 further including one or more supplier and/or service providers linked to the system via the global network.

35. The system of claim 20 wherein there is more than one licensed applicator.

36. The system of claim 20 wherein the licensed applicator is a meat processing plant.
